(19) United States
(12) Patent Application Publication
(10) Pub. No.: US 2008/0168491 A1
(43) Pub. Date: Jul. 10, 2008

(54) SYSTEM AND METHOD TO AUTOMATICALLY TUNE INTO BREAKING WEATHER/NEWS BROADCASTS

(76) Inventors: Michael P. Carlson, Austin, TX (US); Linda A. Lisle, Cedar Park, TX (US); Herman Rodriguez, Austin, TX (US)

Correspondence Address: Greg Goshorn, P.C., 9600 Escarpment, Suite 745-9, AUSTIN, TX, 78749, US

(21) Appl. No.: 11/621,136

(22) Filed: Jan. 9, 2007

(51) Int. Cl. H04N 7/10

(52) U.S. Cl. 725/33

(57) ABSTRACT

Provided is a system and method for defining information of interest to a particular user and for automatically presenting that information on a user defined channel of a media access device. The method is suitable for use with Internet-connected television, or Web TV, and Internet radio. A user defines subject areas of information that are of specific interest to the user. Each subject area is associated with a particular media outlet or channel of the media access device. The method provides means to scan particular channels of the media access device for information that corresponds to the defined subject areas. When information corresponding to a particular subject area is detected, the media access device is, if necessary, switched on and tuned to the particular channel associated with the particular subject area. In addition, means are provided for automatically recording the detected information for playback at a later time.

### TECHNICAL FIELD

The present invention relates generally to emergency notification and, more specifically, to a method for notifying users of important news in a timely fashion.

### BACKGROUND OF THE INVENTION

In the world today, remote events can have a large impact on individuals. It is often important for people to be able to receive notification of such events in a timely fashion. Although, many of the broadcast networks provide notification of “breaking news” as it occurs, many cable channels do not. In addition, the determination of what exactly constitutes breaking news is entirely at the discretion of the media outlet to which a viewer or user is tuned. For example, while news of an eminent tornado will often initiate emergency news coverage, the approach of a hailstorm may not. In both situations, a user may desire to be informed so that the user can, in the case of a tornado, take cover and, in the case of a hailstorm, put an automobile in the garage. Although tornadoes and hail are obvious examples, a particular user may also wish to be notified of a cold front or even light rain. As mentioned above, the user only receives breaking news if they are tuned to a channel or station that is providing that service and, typically, a user receives breaking news on the media outlet to which whatever device they are watching or listening is tuned. In addition, the definition of “breaking news” is determined by the particular media outlet.

With the advent of Internet television, or “web TV,” computers and television and becoming increasingly connected and integrated with the result that many services previously not available are now becoming possible. What is needed is a method of providing the user with more control both over that which is defined as breaking news and over the particular outlet that the user desires to receive that news. For example, a user might define a sudden drop in the stock market as breaking news and desire to have their television automatically switch to a business channel. With the approach of threatening weather, or in fact any change in the weather, a user may desire to switch the channel to a weather channel.

In addition, what are also needed are methods for turning on a media access device in the event that news is breaking when the user does not have the device turned on. A further need is to provide the ability to activate a recording device if a user is not available for listening or viewing.

### SUMMARY OF THE INVENTION

Provided is a system and method for defining information of interest to a particular user and for automatically presenting that information on a user-defined channel of a media access device. The method is suitable for, but not limited to, use with Internet-connected television, or Web TV, and Internet radio. A user defines subject areas of information that are of specific interest to the user. Each subject area is associated with a particular media outlet or channel of the media access device. For example, weather related information is associated with a media channel dedicated to the presentation of weather information and business information is associated with a channel dedicated to the presentation of business information.

The method provides means to scan particular channels of the media access device for information that corresponds to the defined subject areas. When information corresponding to a particular subject area is detected, the media access device is switched to the particular channel associated with the particular subject area. In this manner, a user is instantly informed of the current information in a defined subject area via a channel defined for the specific subject area.

In the event that the media access device is not turned on, the method provides a means for activating the device so that the detected information may be immediately displayed or broadcast to the user even though the user is not currently watching or listening to the device. In addition, means are provided for automatically recording the detected information for playback at a later time. In that case, the information is available later even if the user is not present at the time the information is detected.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is an exemplary multimedia system architecture that includes a media access control device (MACD), implemented according to the claimed subject matter.

FIG. 2 is a block diagram of the MACD of FIG. 1 in more detail.

FIG. 3 is an exemplary SubjectChannelDescriptorObject (SCDO) memory object employed in one implementation of the claimed subject matter.

FIG. 4 is a flowchart of an exemplary Notification Setup process for implementing one aspect of the claimed subject matter.

FIG. 5 is a flowchart of an exemplary Notification Execution process for implementing the claimed subject matter.

### DETAILED DESCRIPTION OF THE FIGURES

Although described with particular reference to an Internet-related media channels, the claimed subject matter can be implemented in any information technology (IT) system in which timely notification of breaking news is desirable. Those with skill in the computing arts will recognize that the disclosed embodiments have relevance to a wide variety of computing and media environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for providing automatic access to breaking news. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

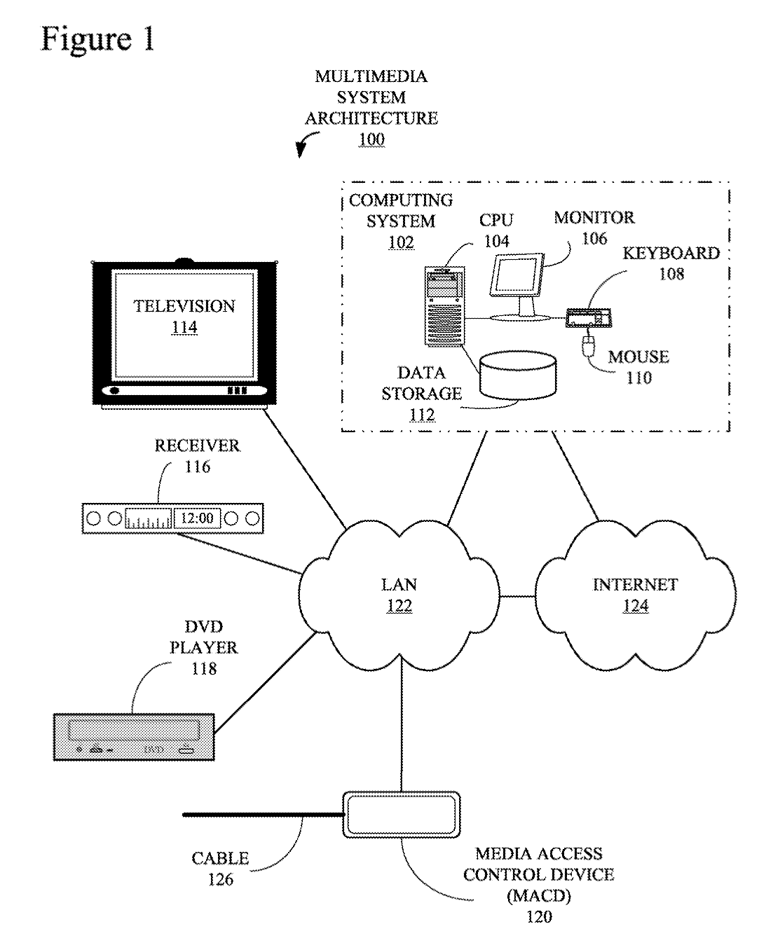

FIG. 1 is an exemplary multimedia system architecture 100 that includes a media access control device (MACD) 120, implemented according to the claimed subject matter. Architecture 100 includes several devices, including a computing system 102, a television 114, a receiver 116 and a DVD player 118. Devices 102, 114, 116, 118 and MACD 120 are communicatively coupled to a local area network (LAN) 122. The connections between LAN 122 and devices 102, 114, 116, 118 and MACD 120 may be, but are not limited to, direct, wired connections, wireless connections or via a LAN hub (not shown). LAN 122 and computing system 102 are also coupled to the Internet 124. Each of devices 114, 116, 118 and 120 may also be communicatively coupled to Internet 124 via LAN 122, computing system 102 or both. Those with skill in the computing and communication arts should appreciate that there are many possible methods for connecting devices to each other in addition to instead of LAN 122 and the Internet 124. The elements of FIG. 1 are used only for the purposes of describing the claimed subject matter and are not intended to limit the claims.

It should be noted that, although devices 102, 114 116, 118 and 120 are illustrated as separate devices; a large degree of integration is possible. For example, the functionality of MACD 120 may be incorporated into computing system 102 and/or television 114 or the recording and playback capabilities of DVD player 118 may be incorporated into television 114 and/or receiver 118. Those with skill in the relevant arts should appreciate the extent to which the capabilities of such devices are currently, and may be, integrated into single units.

Computing system 102 includes a central processing unit (CPU) 104, coupled to a monitor 106, a keyboard 108 and a mouse 110, which together facilitate human interaction with computer 102. Also included in computer 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

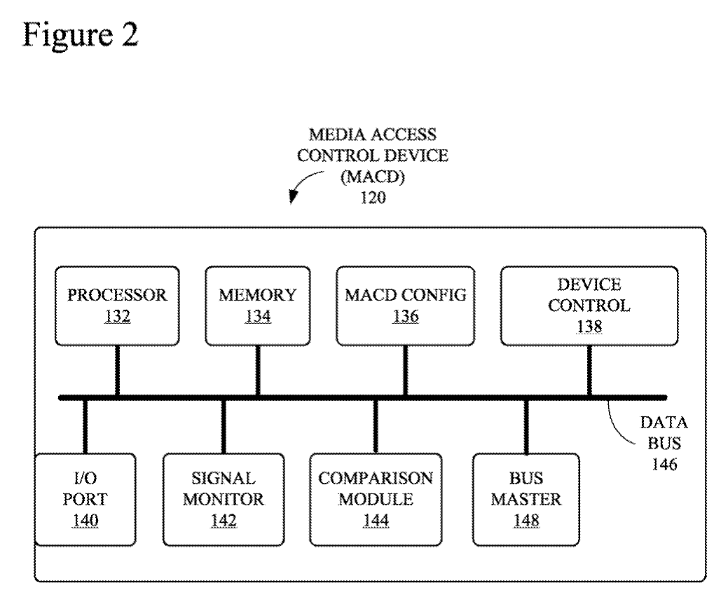

In this example, television 114 and receiver 116 are Internet-enabled or, in other words, are able to download an appropriate signal from Internet 124. MACD 120 is configured to monitor the types of signals processed by television 114 and receiver 116, regardless of whether devices 114 and 116 are powered on or off. MACD 120 is also coupled to a cable 126 and both monitors cable 126 and relays appropriate signals from cable 126 to television 114 and receiver 116. MACD 120 is also configured to send control signals to television 114, receiver 116 and DVD player 118. In the appropriate circumstances, the control signals can initiate a power-on event at the corresponding device 114, 116 and/or 118, change the selected channel on devices 114 and 116 and initiated the recording of a selected signal on DVD device 118 for later playback on one or both of devices 114 and 116. The setup, operation and purpose of the control signals from MASD 120 to devices 114, 116 and 118 are described in more detail below in conjunction with FIGS. 2-5.

FIG. 2 is a block diagram of MACD 120 of FIG. 1 in more detail. Functional modules include a processor 132, a memory 134, a MACD configuration (config.) module 136, a device control module 138, an Input/Output (I/O) port 140, a signal monitor 142 and a comparison module 144. Each of modules 132, 134, 136, 138, 140, 142 and 144 are coupled to a data bus 146, which enables modules 132, 134, 136, 138, 140 and 142 to communicate with each other. Traffic on data bus 146 is controlled by a bus master 148.

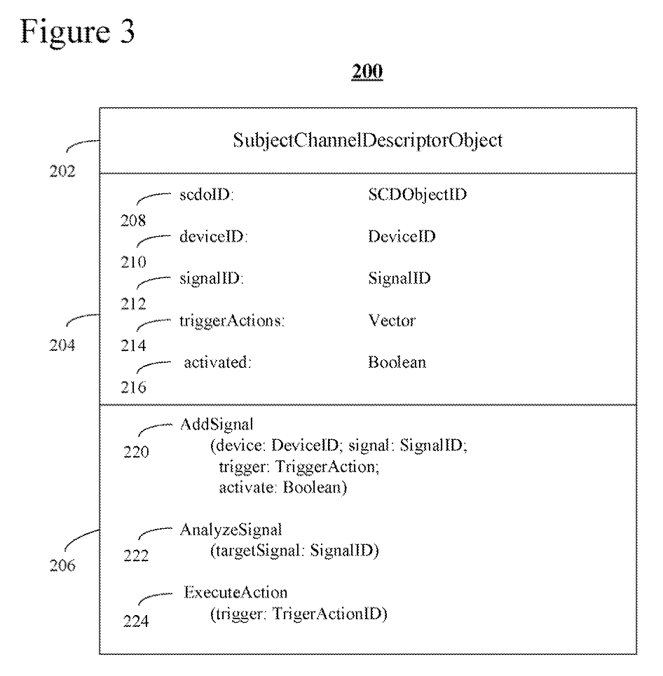

Processor 132 controls the coordination of the modules 134, 136, 138, 140, 142 and 144 to execute the claimed subject matter. Memory 134 provides storage for data and executables employed by processor 132. MACD configuration module 136 provides involatile storage for information employed in the claimed subject matter. An example of one type memory object stored in module 136 is described below in conjunction with FIG. 3. Simply stated, module 136 stores information related to devices, such as television 114 and receiver 116 of FIG. 1, and media streams to be monitored and information on triggers and associated actions to be executed in appropriate circumstances based upon the results of the monitoring. The monitoring of devices and streams is described in more detail below in conjunction with FIGS. 3-5.

Device control 138 stores information relating to the devices, such as television 114, receiver 116 and DVD player 118 (FIG. 1), of architecture 100 (FIG. 1) that may receive a control signal from MACD 120 based upon the triggers detected and associated actions. Specifically, device control 138 stores information relating to the formatting of commands to target devices. Examples of types of commands include, but are not limited to, commands to power on and switch channels on the targeted devices and, in the case of DVD player 118, a command to record a particular media stream.

Input/Output (I/O) port 140 handles communication between MACD 120 and target devices. In addition, I/O port 140 transmits signals from cable 126 (FIG. 1) to the appropriate device in architecture 100. Signal monitor 142 picks out specific signals to monitor based upon information stored in Signal Information objects 200 (see FIG. 3). Comparison module 144 compares streams selected for monitoring by module 142 to data stored in corresponding instances of data object 200 to determine if targeted subject matter is present on the particular stream. There are several possible types of comparisons. For example, module 144 may have sound processing logic for picking keywords form audio streams. Another example, involves the matching of keywords with information contained in data streams associated with particular channels. The claimed subject matter is not limited to these two examples but includes any currently available or yet to be developed method for analyzing a media or information stream for specific content. Examples of targeted content include, but are not limited to, financial information, weather information and any information associated with a particular geographic location based upon zip codes, addresses, global positioning system (GPS) data or any other location attributes.

FIG. 3 is an exemplary SubjectChannelDescriptorObject (SCDO) memory object 200 employed in one implementation of the claimed subject matter. SCDO memory object 200 includes a title section 202, which merely states the name of object 200, i.e. “SubjectChannelDescriptorObject,” an attribute section 204, which contains memory elements, or attributes, associated with SCDO memory object 200, and a method section 206, which includes functions, or methods, that may be executed in conjunction with SCDO memory object 200. It should be noted that the attributes and methods described are used for the purpose of illustration only. Additional and/or different attributes and methods may be employed to implement the claimed subject matter.

Attribute section 202 includes a “scdoID” attribute 208, a “deviceID” attribute 210, a “signalID” attribute 212, a “triggerActions” attribute 214 and an “activated” attribute 216. Instantiations of object 200 are stored in MACD config 136 (FIG. 2) of MACD 120 (FIGS. 1 and 2).

ScdoID attribute 208 is a variable of type SCDObjectID that contains a reference to the particular instance of object 200. Each instance of object 200 has a unique value for attribute 208 that allows each instance to be uniquely identified. DeviceID attribute 210 is a variable of type DeviceID that stores a reference to a particular media device associated with a particular instantiation of object 200. Examples of possible devices are television 114 (FIG. 1), receiver 116 (FIG. 1) and DVD player 118 (FIG. 1). SignalID attribute 212 is a variable of type SignalID that stores a reference to a particular channel associated with a media stream. In the following example, a channel might be associated with an Internet 124 (FIG. 1) domain providing streaming media or a channel associated with cable 126 (FIG. 1).

TriggerActions attribute 214 is a variable of type Vector that stores a record of events, or triggers, that a user has configured MACD 120 to detect on the devices and stream stored in attributes 208 and 210, respectively. Stored in conjunction with each trigger is a list of actions that MACD 120 executes when the corresponding trigger is detected. For example, if MACD 120 detects a trigger corresponding to a significant weather advisory on a channel corresponding to signalID 212, actions defined for execution may be to power on television 114 and change television 114 to the channel associated with signalID 212. Logic associated with any particular trigger is typically stored in memory 134 and executed on processor 132, although specialized functions associated with a particular trigger may be stored and/or executed on one of the specialized modules 138, 140, 142, 144 and 148 (FIG. 2).

Activated attribute 216 is a variable of type Boolean that stores a value indicating whether or not the SCDO object associated with scdoID 208 is currently active. In other words, MACD 120 provides the ability to define actions associates with particular devices and media streams that may be executed in the future but are currently inactive.

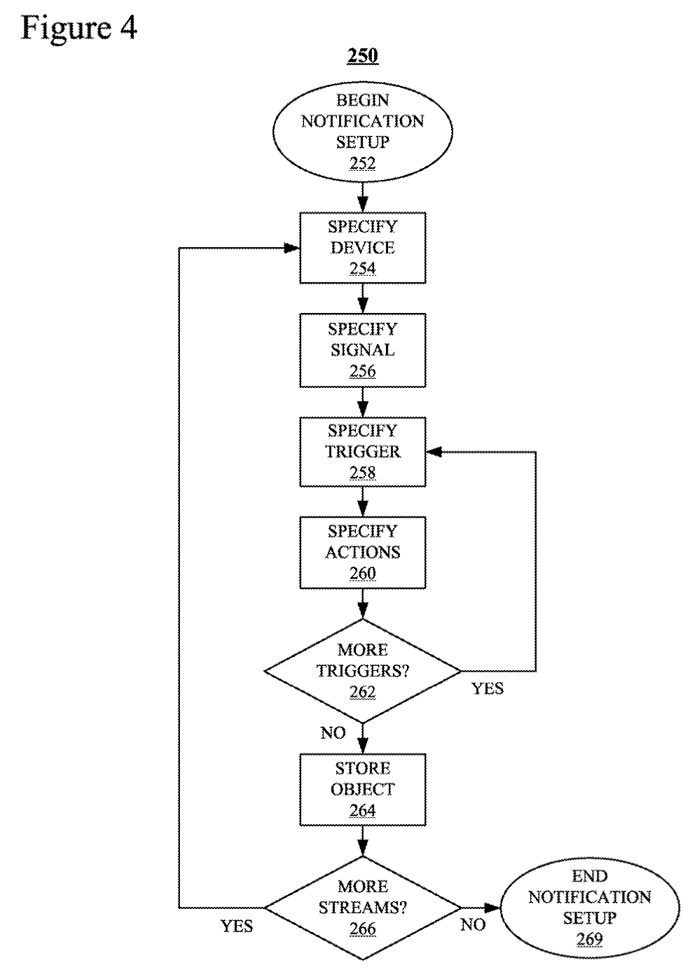

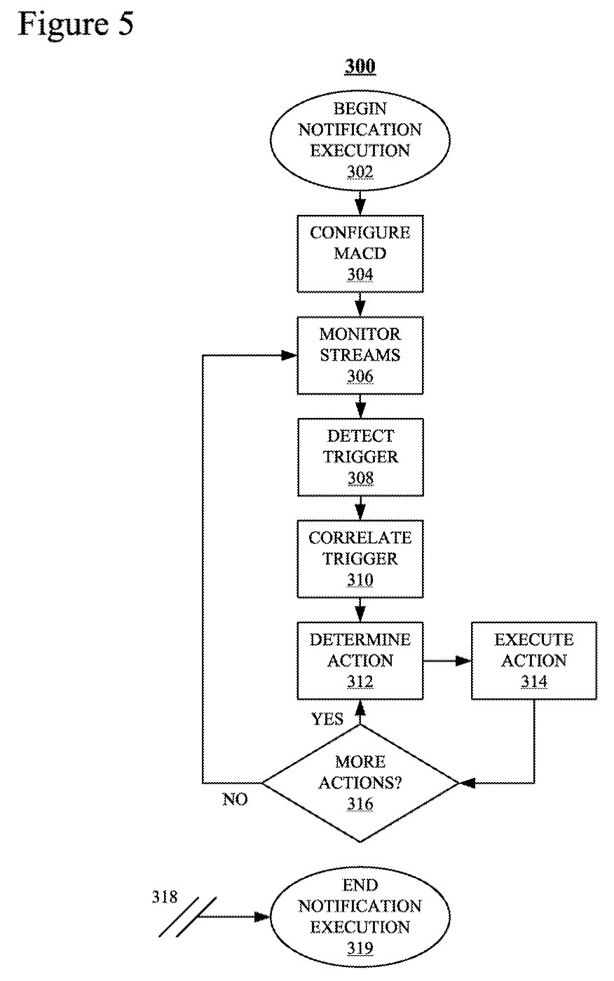

Method section 206 of object 200 includes three (3) exemplary functions, or methods; i.e. an “AddSignal” method 220, an “AnalyzeSignal” method 222 and an “ExecuteAction” method 224. Methods 220, 222 and 224 are described in more detail below in conjunction with FIGS. 4 and 5. Simply stated, AddSignal method 220 is executed to designate a particular signal of a particular device for monitoring; “AnalyzeSignal method 222 is executed to monitor a particular signal; and ExecuteAction method 224 is executed to initiate an action associated with a particular signal once a trigger has been detected.

Only three methods are illustrated for the sake of simplicity. Those with skill in the programming arts should appreciate that an object such as object 200 would typically include many additional methods including, but not limited to, constructors, destructors, and methods to set and get values for various attributes. It should be understood that SCDO object 200 is only one example of a memory object that may be used to implement the claimed subject matter. Other memory objects with fewer, more and/or different attributes and methods may be employed. In addition, there are many ways other than employing object 200 to implement the functionality and data storage of the claimed subject matter. For example, the claimed subject matter may be implemented by means of a computer program in conjunction with a relational database.

FIG. 4 is a flowchart of an exemplary Notification Setup process 250 for implementing one aspect of the claimed subject matter. Specifically, process 250 enables a user to designate devices and signals for monitoring, i.e. designating a device and signal, defining one or more trigger events and associating one or more actions to the designated trigger(s). Process 250 is accessed via a graphical user interface (GUI) (not shown) displayed on monitor 106 (FIG. 1) of computing system 102 (FIG. 1). As explained above in conjunction with FIG. 1, in this example, computing system 102 is communicatively coupled to MACD 120 (FIGS. 1 and 2) via both LAN 122 (FIG. 1) and Internet 124 (FIG. 1). Either LAN 122 or Internet 124 may be employed for communication between MACD 120 and computing system 102, depending upon which is available at any particular time. As explained above in conjunction with FIG. 2, MACD 120 communicates via I/O port 140 (FIG. 2). In this example, process 250 is executed on CPU 104 (FIG. 1) and the results are transmitted to MACD 120 as a SCDObject 200 (FIG. 3) and stored in MACD config module 136 (FIG. 2). In one possible alternative embodiment, process 250 is executed on processor 132 (FIG. 2) of MACD 120 and only the corresponding GUI is executed on computing system 102. In another possible embodiment, process 250 is executed on MACD 120 and the GUI is displayed on a user interface (not shown) associated with MACD 120.

Process 250 starts in a “Begin Notification Setup” block 252 and proceeds immediately to a “Specify Device” block 254. During block 254, process 250 enables a user to specify a particular device for monitoring in accordance with the claimed subject matter. The GUI associated with process 250 enables the user to specify a particular device by entering identifying information, such as but not limited to an Internet protocol (IP) address corresponding to the device or, in the alternative, provides a list of possible devices and enables the user to select a device from the list. In this example, the device may be one of television 114 or receiver 116. During a “Specify Signal” block 256, the GUI of process 250 enables the user to specify a particular signal associated with the device selected during block 254. Again, the user may either enter identifying information associated with the signal or select the signal from a list of available signals corresponding to the selected device.

During a “Specify Trigger” block 258, the GUI of process 250 enables the user to enter information corresponding to a particular event for which the user would like MACD 120 to screen, or filter, the signal selected during block 256. For example, during block 254, the user may select television 114, during block 256, select a weather channel (not shown) associated with television 114 and, during block 258 select the word “hail.” This would start the configuration of MACD 120 for monitoring the weather channel for any reference to the word “hail.” As explained below in conjunction with FIG. 5, the word “hail” may either be converted to a digital audio signature used to filter an audio stream or converted to a text filter that screens an information data stream associated with the selected stream.

During a “Specify Actions” block 260, the GUI of process 250 enables a user to specify one or more actions to associate with the trigger defined during block 258. As explained in more detail below in conjunction with FIG. 5, one example of such an action is to send a power on signal to the device specified during block 254, transmit a command for the device to change to the channel specified during block 258 and transmit a signal to DVD player 118 (FIG. 1) to record the channel.

During a “More Triggers” block 262, the user may indicate a desire to define more trigger associated with the device defined or selected during block 254 and the signal defined or selected during block 256. If the user indicates a desire to define additional triggers, process 250 returns to block 258 and processing continues as described above. Iterations through blocks 258, 260 and 262 produce entries in triggerActions attribute 214 (FIG. 3) of a corresponding SCDObject 200 (FIG. 3).

If the user indicates during block 262 that no more trigger/action pairs need be defined, process 250 proceeds to a “Store Object” block 264 during which process 250 stores the corresponding memory object 200 in MACD config module 136. Process 250 then proceeds to a “More Streams” block 266. During block 264, the user may indicate a desire to configure addition device/channel pairs. If the user indicates a desire to define additional device/channel pairs, process 250 returns to block 254 and processing continues as described above. If not, process 250 proceeds to an “End Notification Setup” block 269 in which process 250 is complete. It should be noted that each iteration through blocks 254, 256, 258, 260 262 and 264 produces an SCDObject 200 stored in MACD config module 136.

FIG. 5 is a flowchart of an exemplary Notification Execution process 300 for implementing the claimed subject matter. Process 300 is executed on processor 132 (FIG. 2) of MACD 120 (FIGS. 1 and 2). Process 300 starts in a “Begin Notification Execution” block 302 and proceeds immediately to a “Configure MACD” block 304. During block 304, loads executable code from memory 134 (FIG. 2) into processor 132. The loaded code is populated with information from MACD Configuration module 136 (FIG. 2). As explained above in conjunction with FIG. 4, the stored in module 136 was entered during instantiations of process 250 and defined devices, streams, triggers and actions according to the claimed subject matter. In addition, the configuration of MACD 120 may include a GUI directed to enabling a user to select among several SCDObject memory objects 200, defined as explained above in conjunction with FIG. 4.

During a “Monitor Streams” block 306, process 300 employs signal monitor 142 (FIG. 2) and comparison module 144 (FIG. 2) to monitor defined devices and streams for triggers associated with instantiations of defined SCDObject 200 (FIG. 3). Block 306 corresponds to multiple executions of AnalyzeSignal method 224 (FIG. 3), each execution corresponding to a particular instantiation of SCDObject 200. Once a particular trigger is detected during a “Detect Trigger” block 308, process 300 proceeds to a “Correlate Trigger” block 310. During block 308, process 300 correlates the detected trigger to the associated device and signal.

During a “Determine Action” block 312, process 300 retrieves the action or actions associated with the detected trigger and select one of the action or actions that have not yet been executed during the current iteration. The association of triggers with actions is explained above in conjunction with FIG. 4. During an “Execute Action” block 314, process 300 executes the action selected during block 312. Such actions may include, but are not limited to, commands, stored in device control 138 (FIG. 2), to devices such as television 114, receiver 116 and DVD player 118 via I/O port 140. Block 314 corresponds to ExecuteAction method 224 (FIG. 3).

During a “More Actions” block 316, process 300 determines whether or not there are unexecuted actions associated with the trigger detected during block 308. If so, process 300 returns to block 312, selects another unexecuted action and processing continues as described above. If not, process 300 returns to block 306 and continues to monitor selected streams as described above.

Finally, in the event MACD 120 is shut down or loses power, an asynchronous interrupt 318 is generated and process 300 proceeds to an “End Notification Execution” block 319 in which process 300 is complete. Interrupt 318 is employed to terminate execution of process 300 because in typically operation process 300 executes continuously.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for controlling a media access device, comprising:
designating a media access device;
designating a media stream associated with the media access device;
defining a trigger associated with content corresponding to the media stream;
defining an action associated with the trigger;
monitoring the media stream for the presence of the trigger; and
initiating the action on the media access device when the trigger is detected in the media stream.

2. The method of claim 1, further comprising:
defining a second trigger associated with content corresponding to the media stream;
defining a second action associated with the second trigger;
monitoring the media stream for the presence of the second trigger; and
initiating the second action on the media access device when the second trigger is detected in the media stream.

3. The method of claim 1, wherein the media access device is a television and the media stream is an Internet television stream.

4. The method of claim 1, wherein the action is to transmit a power-on command to the media device.

5. The method of claim 1, wherein the action is to transmit a command to the media device to tune the media access device to the designated media stream.

6. The method of claim 1, wherein the action is to transmit a command to a second device to record the designated media stream.

7. The method of claim 1, wherein the trigger is information of interest to a particular user.

8. A media access control device, comprising:
a media access device;
a media stream associated with the media access device;
a trigger associated with content corresponding to the media stream;
an action associated with the trigger;
logic for monitoring the media stream for the presence of the trigger; and
logic for initiating the action on the media access device when the trigger is detected in the media stream.

9. The device of claim 8, further comprising:
a second trigger associated with content corresponding to the media stream;
a second action associated with the second trigger;
logic for monitoring the media stream for the presence of the second trigger; and
logic for initiating the second action on the media access device when the second trigger is detected in the media stream.

10. The device of claim 8, wherein the media access device is a television and the media stream is an Internet television stream.

11. The device of claim 8, wherein the action is a transmission of a power-on command.

12. The device of claim 8, wherein the action is a transmission of a command to the media device to tune the media access device to the designated media stream.

13. The device of claim 8, wherein the action is a transmission of a command to a second device to record the designated media stream.

14. The device of claim 8, wherein the trigger is information of interest to a particular user.

15. A computer programming product for controlling a media access device, comprising:
a memory;
logic, stored on the memory, for designating a media access device;
logic, stored on the memory, for designating a media stream associated with the media access device;
logic, stored on the memory, for defining a trigger associated with content corresponding to the media stream;
logic, stored on the memory, for defining an action associated with the trigger;
logic, stored on the memory, for monitoring the media stream for the presence of the trigger; and
logic, stored on the memory, for initiating the action on the media access device when the trigger is detected in the media stream.

16. The computer programming product of claim 15, further comprising:
logic, stored on the memory, for defining a second trigger associated with content corresponding to the media stream;
logic, stored on the memory, for defining a second action associated with the second trigger;
logic, stored on the memory, for monitoring the media stream for the presence of the second trigger; and
logic, stored on the memory, for initiating the second action when the second trigger is detected in the media stream.

17. The computer programming product of claim 15, wherein the media access device is a television and the media stream is an Internet television stream.

18. The computer programming product of claim 15, wherein the action is to transmit a power-on command to the media device.

19. The computer programming product of claim 15, wherein the action is to transmit a command to the media device to tune the media access device to the designated media stream.

20. The computer programming product of claim 15, wherein the action is to transmit a command to a second device to record the designated media stream.
